(19) United States
(12) Patent Application Publication
(10) Pub. No.: US 2008/0306636 A1
(43) Pub. Date: Dec. 11, 2008

(54) ENHANCED DISPLAY FOR PRESENTING TACHOMETER INFORMATION

(75) Inventors: Martin Jay Caspe-Detzer, Fall City, WA (US); Andrew Joseph Ressa, Kirkland, WA (US); Phu Vi Tran, Renton, WA (US); Ian David O'Connor, Seattle, WA (US); John William Espinosa, Aubrey, TX (US); Paul Stephen Crowe, Aubrey, TX (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: PACCAR INC, Bellevue, WA (US)

(21) Appl. No.: 11/758,880

(22) Filed: Jun. 6, 2007

(51) Int. Cl. B60Q 1/54; G01P 3/42

(52) U.S. Cl. 701/1; 324/160; 340/461

(57) ABSTRACT

Aspects of the present invention are directed at an enhanced display for presenting tachometer information. In accordance with one embodiment, a method is provided that causes an electronic control unit associated with a dashboard display to present the current engine speed (e.g. RPM) relative to an optimal range in which fuel efficiency is maximized. More specifically, the method includes obtaining a set of tachometer data at the electronic control unit that defines the lower and upper limits of the optimal range in which fuel efficiency is maximized. Periodically, the current engine speed may be obtained by the electronic control unit associated with the dashboard display. Then, the method causes the current engine speed to be presented on the graphical display relative to the lower and upper limits of the optimal range.

### FIELD OF THE INVENTION

The present invention is generally related to display systems for presenting information to a vehicle operator.

### BACKGROUND

Increasing demands are being placed on finite energy reserves used to power vehicles such as cars, trucks, and the like. In this regard, improvements to make vehicles more fuel-efficient provide benefits of minimizing transportation costs and reducing environmental pollutants. The primary focus of recent technological advances for making vehicles more fuel efficient has focused on utilizing different types of fuel sources and/or improving the efficiency in which mechanical components consume fuel. However, excess fuel may be consumed because of operational inefficiencies caused by a vehicle operator. For example, a vehicle operator may negatively impact fuel consumption by not maintaining sufficient tire pressure, accelerating/decelerating too rapidly, and the like.

In some vehicles, a dashboard display includes a “tachometer” for presenting engine speed information to a vehicle operator. One skilled in the art will recognize that the engine speed information is typically reported on the tachometer as the number of revolutions that an engine crankshaft rotates in a unit of time, e.g., Revolutions Per Minute (“RPM”). Moreover, existing tachometers may provide indicators regarding whether the engine speed is operating at a potentially harmful level. As a result, a vehicle operator may modify the gearing ratio so that the engine does not operate above the potentially harmful RPM level.

In existing systems, a vehicle operator may not readily access information regarding whether the current engine speed is at a level that maximizes fuel efficiency. In this regard, the amount of fuel consumed by an engine is at least partially dependent on the speed in which the engine produces power. In other words, fuel efficiency is maximized when the engine's speed is maintained in a “sweet spot” or optimal range (e.g., 1100-1800 RPM). When the engine's speed is outside of the optimal range there is a corresponding reduction in fuel efficiency. Unfortunately, existing systems may only report engine speeds relative to potentially harmful levels. Information regarding engine speeds relative to an optimal range in which fuel efficiency is maximized is not readily available. As a result, a vehicle operator may not have sufficient information to adjust driving habits in order to minimize the amount of fuel consumed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the present invention are directed at an enhanced display for presenting tachometer information. In accordance with one embodiment, a method is provided that causes an electronic control unit associated with a dashboard display to present the current engine speed (e.g. RPM) relative to an optimal range in which fuel efficiency is maximized. More specifically, the method includes obtaining a set of tachometer data at the electronic control unit that defines the lower and upper limits of the optimal range in which fuel efficiency is maximized. Periodically, the current engine speed may be obtained from a vehicle's engine. Then, the method causes the current engine speed to be presented on the graphical display relative to the lower and upper limits of the optimal range.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial depiction of an exemplary system architecture with electronic components that may be used to implement aspects of the present invention;

FIGS. 2A-2C are exemplary graphical displays that present engine speed information in accordance with one embodiment of the present invention; and

FIG. 3 is an exemplary flow diagram for gathering and presenting engine speed information in accordance with another embodiment of the present invention.

### DETAILED DESCRIPTION

Prior to discussing the details of the invention, it should be understood that the following description is presented largely in terms of logic and operations that may be performed by conventional electronic components. These electronic components, which may be grouped in a single location or distributed over a wide area, generally include processors, memory, storage devices, display devices, input devices, etc. In circumstances where the components are distributed, the components are accessible to each other via communication links. In the following description, numerous specific details are set forth in order to provide a thorough understanding of the invention. It will be apparent to one skilled in the art, however, that the invention may be practiced without some or all of the specific details. In some instances, well-known process steps have not been described in detail in order not to unnecessarily obscure the invention.

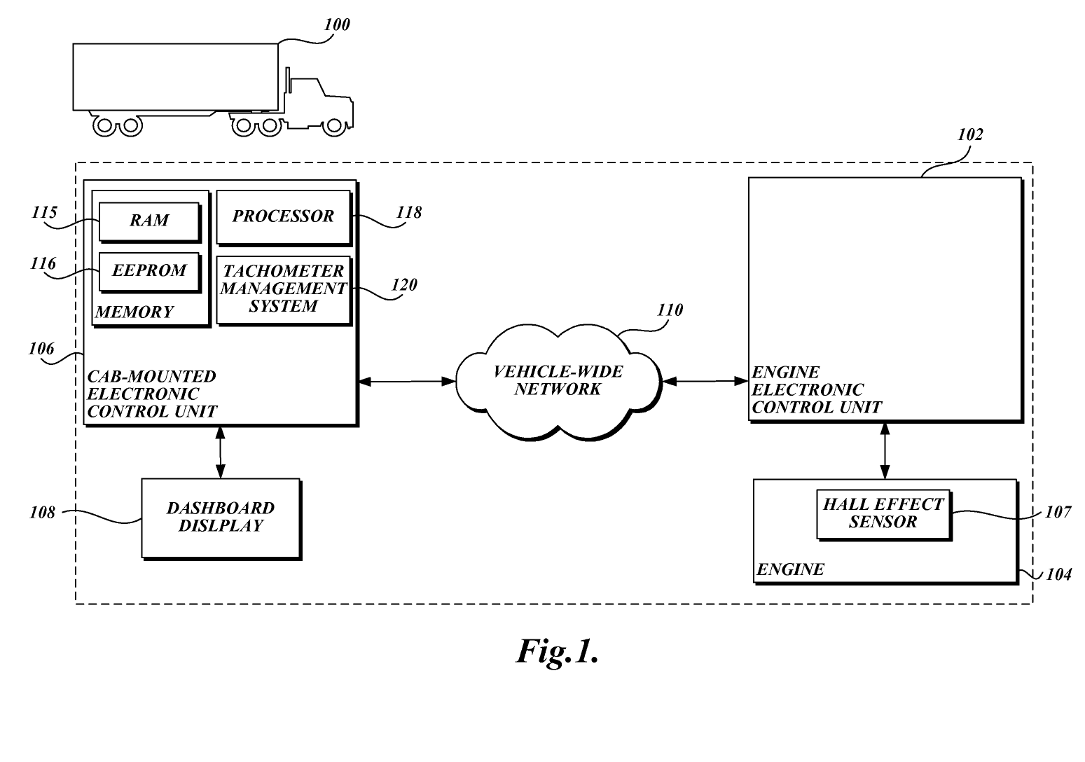

FIG. 1 and the following discussion is intended to provide a brief, general description of a system architecture in a truck 100 that may implement aspects of the present invention. As illustrated in FIG. 1, the truck 100 includes an engine electronic control unit 102 that is associated with an engine 104. Moreover, the truck 100 also includes a cab-mounted electronic control unit 106 that is associated with a dashboard display 108. One of ordinary skill in the art will appreciate that the system architecture of the truck 100 will include many more components than those depicted in FIG. 1. However, it is not necessary that all of these generally conventional components be shown or described in order to disclose an illustrative embodiment for practicing the present invention.

As further illustrated in FIG. 1, the electronic control units 102 and 106 are communicatively connected via the vehicle-wide network 110. Those skilled in the art and others will recognize that the vehicle-wide network 110 may be implemented using any number of different communication protocols such as, but not limited to, Society of Automotive Engineer's (“SAE”) J1587 and SAE J1939. However, the invention may be implemented using other types of currently existing, or yet to be developed, in-vehicle communication systems without departing from the scope of the claimed subject matter.

The system architecture for the truck 100 depicted in FIG. 1 includes the electronic control unit 102 for managing various aspects of the engine's 104 operation. For example, the engine's 104 ignition timing, fuel consumption, and the like, may be monitored by the electronic control unit 102. With regard to the present invention, the electronic control unit 102 may be configured to calculate engine speed information. In addition, engine speed information may also be obtained from other components, such as the hall effect sensor 107 that is typically located on the engine's 104 crankshaft. In this regard, the engine speed information may be communicated to other electronic components in the truck 100 via the vehicle-wide network 110. For example, engine speed information may be transmitted via the vehicle-wide network 110 to the cab-mounted electronic control unit 106. While FIG. 1 depicts an embodiment in which engine speed information is obtained from either an electronic control unit 102 or the hall-effect sensor 107, those skilled in the art and others will recognize that other components may be used to obtain engine speed information without departing from the scope of the claimed subject matter.

In the illustrative embodiment depicted in FIG. 1, the truck 100 includes a cab-mounted electronic control unit 106. Generally described, the cab-mounted electronic control unit 106 serves as an interface between the vehicle operator and components of the truck 100. In this regard, the cab-mounted electronic control unit 106 may communicate with other electronic components of the truck 100 over the vehicle-wide network 110. Data collected from the electronic components may be presented to a vehicle operator. For example, data received from electronic components associated with vehicle subsystems (collision detection, engine operation, cruise control, and the like) may be received by the cab-mounted electronic control unit 106 and presented on the dashboard display 108.

As further illustrated in FIG. 1, the cab-mounted electronic control unit 106 includes a memory 114 with a Random Access Memory (“RAM”) 115, and an Electronically Erasable, Programmable, Read-only Memory (“EEPROM”) 116, a processor 118, and a tachometer display system 120. Those skilled in the art and others will recognize that the EEPROM 116 is a non-volatile memory capable of storing data when a vehicle is not operating. Conversely, the RAM 115 is a volatile form of memory for storing program instructions that are readily accessible by the processor 118. Typically, a fetch and execute cycle in which instructions are sequentially “fetched” from the RAM 115 and executed by the processor 118 is performed. In this regard, the processor 118 is configured to operate in accordance with program instructions that are sequentially fetched from the RAM 115.

Aspects of the present invention may be implemented in the tachometer display system 120. In this regard, the tachometer display system 120 may be loaded from the EEPROM 116 into the RAM 115 at vehicle startup. In one embodiment, the tachometer display system 120 regularly receives engine speed information from a communicatively connected device, such as electronic control unit 102. The engine speed information is processed into both a numeric and graphical representation and presented on the dashboard display 108. The graphical representation includes a bar graph that displays the current engine speed information relative to an optimal range in which fuel efficiency is maximized. In this regard, visual, auditory, and/or haptic feedback may be provided so that the vehicle operator may readily identify whether the current engine speed is in the optimal range. As a result, information is available that will allow a vehicle operator to adjust driving habits in order to minimize fuel consumption.

As will be appreciated by those skilled in the art and others, FIG. 1 provides a simplified example of one system architecture for implementing the present invention in the truck 100. In other embodiments, the features of the truck 100 may be implemented using different components. For example, while FIG. 1 describes a system in which vehicle speed information is obtained from an electronic control unit associated with a vehicle's engine, those skilled in the art and others will recognize that this information may be obtained from other components. Thus, FIG. 1 provides one system architecture that may be used to implement the invention.

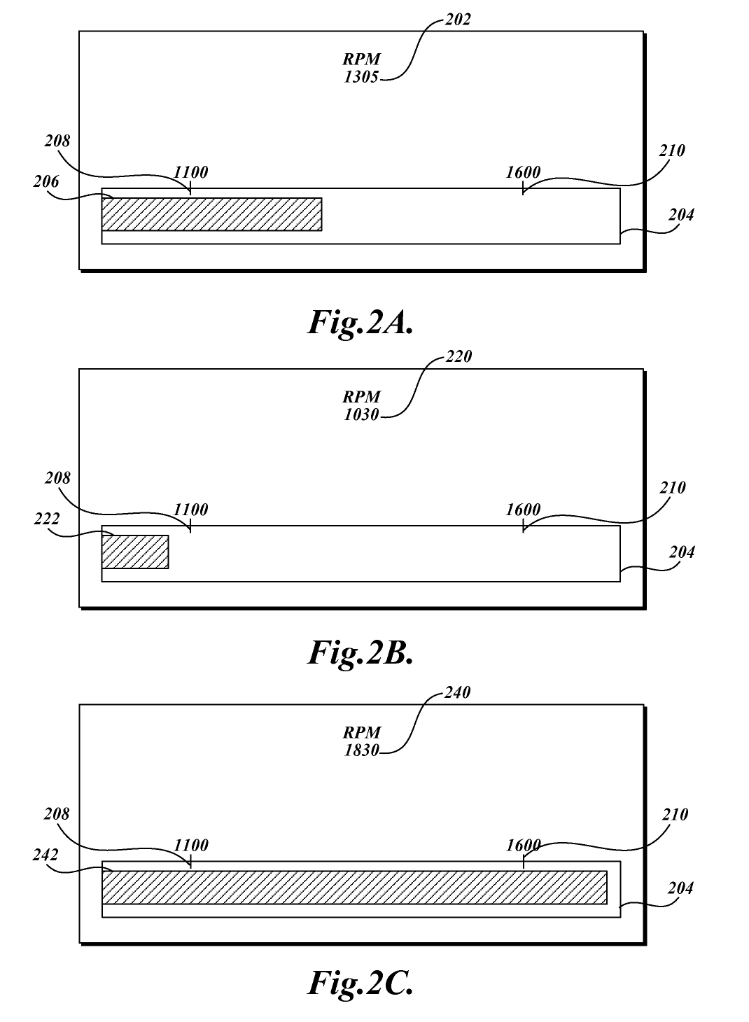

Now with reference to FIGS. 2A-C, a representative section of a dashboard display 200 that illustrates aspects of the present invention will be described. As mentioned previously, existing tachometers may be configured to display engine speed information. For example, a commonly used needle-sweep tachometer presents the current engine speed relative to a total range of possible RPM values. In this regard, indicators are typically provided to identify potentially unsafe engine speeds that, if achieved, may cause damage to a vehicle's engine. Aspects of the present invention may be used in conjunction with or as an improvement to these types of existing tachometers. However, engine speed information is presented relative to optimal range in which fuel consumption is minimized.

For illustrative purposes, FIG. 2A depicts an exemplary graphical display 200 for presenting engine speed information to a vehicle operator. In this embodiment, the graphical display 200 includes a numerical representation 202 of the current engine RPM (“RPM 1305”). Also, a bar graph 204 is provided that graphically depicts the current engine RPM on a slider 206. In this regard, the bar graph 204 includes scale indicators 208 and 210 that represent the lower limit (e.g., 1100 RPM) and upper limit (e.g., 1600 RPM) of the optimal range, respectively. As the engine RPM changes, the slider 206 moves along the bar graph 204 to graphically depict the current engine speed.

Aspects of the present may provide additional visual, auditory, and/or haptic feedback to convey information regarding whether the current engine RPM is in the optimal range. In the example depicted in FIG. 2A, the current engine RPM (e.g., 1308) is in the optimal range (e.g., 1100-1800). By way of example only, to provide additional feedback that the current engine RPM is in the optimal range, the numeric representation 202 and/or the bar graph 204 may be presented on the graphical display 200 in a “normal” color (e.g., green). By presenting the engine speed in this way, readily understandable information is provided to indicate that the engine RPM is in the optimal range.

FIG. 2B includes the same graphical display 200 that was described above with reference to FIG. 2A. However, in this instance, the numeric representation 220 indicates that the current engine RPM (e.g., 1030) is below the lower limit of the optimal range. Accordingly, the slider 222 on the bar graph 204 visually depicts that the current engine RPM is less than the RPM value represented by the scale indicator 208. Similar to the description provided above with reference to FIG. 2A, other visual, auditory, and/or haptic feedback may be provided to indicate the current engine RPM is below the lower limit of the optimal range. By way of example only, when the engine RPM intersects the lower limit of the optimal range, the numeric representation 220 and/or bar graph 204 may change colors from green to yellow. This change provides a visual indicator that the current engine RPM has fallen below the lower limit of the optimal range.

FIG. 2C includes the same graphical display 200 that was described above with reference to FIGS. 2A-B. However, in this instance, the numeric representation 240 indicates that the current engine RPM (e.g., 1830) is above the upper limit of the optimal range. Accordingly, the slider 242 on the bar graph 204 visually depicts that the current engine RPM is more than the RPM value represented by the scale indicator 210. Similar to the description provided above with reference to FIGS. 2A-B, other visual, auditory, and/or haptic feedback may be provided when the current engine speed is above the upper limit of the optimal range. By way of example only, when the engine RPM intersects the upper limit of the optimal range, the numeric representation 240 and/or bar graph 204 may change colors from green to red. This change provides a visual indicator that the current engine RPM has proceeded above the upper limit of the optimal range.

For the sake of convenience, much of the description above with reference to FIGS. 2A-C is provided in the context of exemplary interfaces. However, it should be well understood that the present invention is applicable in other contexts and the exemplary interfaces described herein should not be construed as limiting of the invention. In this regard, specific examples of mechanisms for conveying the status of the engine RPM relative to the optimal range have been provided. However, in alternative embodiments, other types of visual, auditory, and/or haptic feedback may be provided without departing from the scope of the claimed subject matter.

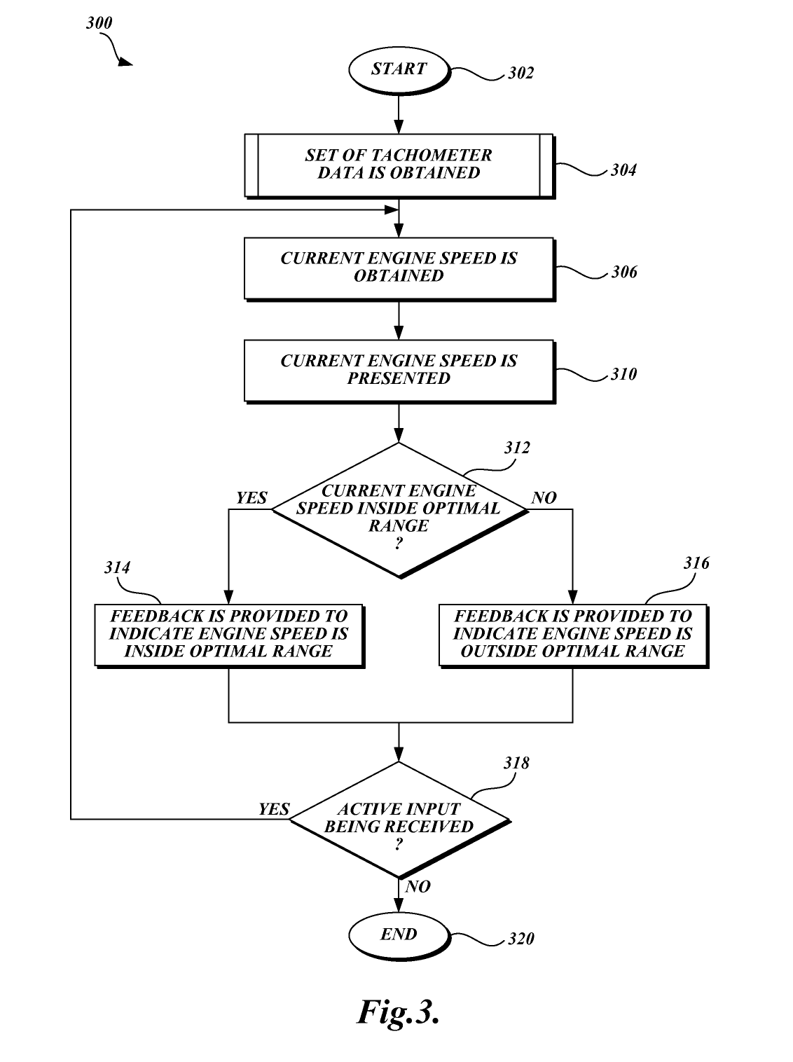

Now with reference to FIG. 3, a flow diagram that depicts one exemplary embodiment of a display method 300 formed in accordance with the present invention will be described. Generally stated, engine speed information is obtained and displayed relative to an optimal range so that a vehicle operator may adjust driving habits to minimize fuel consumption. In this regard, the display method 300 may be implemented by the tachometer display system 120 in the cab-mounted electronic control unit 106 (FIG. 1). Accordingly, current engine speed information may be obtained and presented on a graphical display 200, as described above with reference to FIGS. 2A-C.

As illustrated in FIG. 3, the display method 300 begins at block 302, and at block 304, a set of tachometer data is obtained that identifies the optimal range in which fuel efficiency is maximized. In one embodiment, the upper and lower limits of the optimal range are accessed from the engine electronic control unit 102. In this regard, the optimal range may be defined by the engine manufacturer and stored in the memory of the electronic control unit 102. This data may be transmitted to the cab-mounted electronic control unit 106 over the vehicle wide network 110 where the data is available to the display method 300. As described above with reference to FIGS. 2A-2C, actual engine speed may be presented on a graphical display relative to the optimal range. In this way, aspects of the present invention allow an engine manufacturer to provide information about the attributes of an engine so that fuel consumption may be minimized.

At block 306, data is received that includes the current engine speed or rate in which the engine's crankshaft is rotating. In one embodiment, the engine speed is periodically transmitted over the network 110 to the cab-mounted electronic control unit 106 where it is available to the display method 300. In this regard, those skilled in the art and others will recognize that the engine speed may be quantified and reported by any number of different vehicle components. By way of example only, the engine speed may be reported from the electronic control unit 102 associated with a vehicle's engine 104, the hall-effect sensor 107, and the like.

At block 310, the current engine speed is presented to a vehicle operator. In one embodiment, the engine speed is presented both numerically and graphically. More specifically, data displayed to a vehicle operator on the graphical display 200 (FIGS. 2A-C) may be “refreshed” based on the engine speed information obtained, at block 306. However, since refreshing data that is presented on a graphical display may be performed using techniques that are generally known in the art, these techniques will not be described here.

At decision block 312, a test is performed to determine whether the current engine speed is in the optimal range as defined by the engine manufacturer. When block 312 is reached, data obtained from different sources may be compared to determine whether the current engine speed is in the optimal range. More specifically, the set of tachometer data obtained at block 302 may be compared with the current engine speed that was obtained at block 310. In this regard, if the current engine speed is outside the optimal range as defined in the tachometer data provided by the engine manufacturer, the display method 300 proceeds to block 316, described in further detail below. Conversely, if the current engine speed is in the optimal range, the display method 300 proceeds to block 314.

At block 314, visual, auditory, and/or haptic feedback is provided to indicate that the current engine speed is in the optimal range. As described above with reference to FIG. 2A, to indicate that the current engine speed is in the optimal range, information may be conveyed using different colors. For example, when the current engine speed is in the optimal range, data may be presented on the graphical display 200 in a normal color (e.g., green). By presenting engine speed information in this way, a readily understandable indicator is available regarding whether the current engine speed is in the optimal range. Then the display method 300 proceeds to block 318, described below.

At block 316, visual, auditory, and/or haptic feedback is provided to indicate that the current engine speed is outside the optimal range. As described above with reference to FIGS. 2B-C, to indicate that the current engine speed is outside the optimal range, information may be conveyed on a graphical display using different colors. For example, if the current engine speed is above the upper limit of the optimal range, data may be presented on a graphical display 200 in the color red. By way of another example, if the current speed is below the lower limit of the optimal range, the tachometer data may be presented on the graphical display 200 in the color yellow. However, these examples should be construed as exemplary as other types of feedback may be provided to convey the relationship between the current engine speed relative to the optimal range. Then the display method 300 proceeds to block 318, described below.

At decision block 318, a determination is made regarding whether active input of tachometer data is being received. Active input may not be received when operation of the vehicle terminates or the vehicle remains idle for a predetermined amount of time. If active input is being received, the display method 300 proceeds back to block 302 and blocks 302-318 repeat until input is no longer being received. Conversely, if active input is not being received, the display method 300 proceeds to block 320, where it terminates.

While illustrative embodiments have been illustrated and described, it will be appreciated that various changes can be made therein without departing from the spirit and scope of the invention.

The embodiments of the invention in which an exclusive property or privilege is claimed are defined as follows:

1. In a vehicle that includes an electronic control unit that is communicatively connected to a graphical display, a method of displaying a current engine speed relative to an optimal range, the method comprising:
obtaining a set of tachometer data at the electronic control unit that defines lower and upper limits of the optimal range;
obtaining a current engine speed at the electronic control unit that quantifies a rate an engine crankshaft is rotating; and
presenting the current engine speed on the graphical display relative to the lower and upper limits of the optimal range.

2. The method as recited in claim 1, wherein the graphical display is presented in a first color when the current engine speed is in the optimal range and in a color different than the first color when the engine speed not in the optimal range.

3. The method as recited in claim 1, further comprising providing auditory feedback to indicate whether the current engine speed is outside the optimal range.

4. The method as recited in claim 1, wherein the set of tachometer data is obtained from memory of an electronic control unit associated with the vehicle's engine.

5. The method as recited in claim 1, wherein the current engine speed is obtained from a hall effect sensor.

6. The method as recited in claim 1, wherein the current engine speed is depicted in both a numeric and graphical form on the graphical display.

7. The method as recited in claim 1, wherein presenting the current engine speed on a graphical display includes creating a bar chart with scale indicators that identify the lower and upper limits of the optimal range.

8. An electronic control unit, comprising:
a memory for storing data; and
a processor communicatively coupled to the memory, wherein the processor is operative to:
cause an accumulation in the memory of a set of tachometer data that defines the lower and upper limits of an optimal range in which fuel efficiency is maximized and the current engine speed that represents a rate in which an engine crankshaft is rotating;
perform a comparison between the upper and lower limits of the optimal range and the current engine speed;
cause the current engine speed to be presented on the graphical display relative to the lower and upper limits of the optimal range; and
provide feedback indicative of whether the current engine speed is in the optimal range.

9. The electronic control unit as recited in claim 8, wherein the set of tachometer data that defines the lower and upper limits of the optimal range and the current engine speed is obtained from a communicatively connected electronic control unit that is associated with a vehicle's engine.

10. The electronic control unit as recited in claim 8, wherein the current engine speed is obtained from a communicatively connected hall effect sensor.

11. The electronic control unit as recited in claim 8, wherein the current engine speed is depicted in both a numeric and graphical form on the graphical display.

12. The electronic control unit as recited in claim 8, wherein to cause the current engine speed to be displayed relative to the optimal range includes creating a bar chart with scale indicators that identify the lower and upper limits of the optimal range.

13. The electronic control unit as recited in claim 8, wherein the indication of whether the current engine speed is in the optimal range is the initiation of auditory feedback when the engine speed intersects the limits of the optimal range.

14. The electronic control unit as recited in claim 8, wherein the indication of whether the current engine speed is in the optimal range is the initiation of haptic feedback when the engine speed intersects the limits of the optimal range.

15. The electronic control unit as recited in claim 8, wherein to cause the current engine speed to be presented includes presenting information in different colors on the graphical display depending on whether the current engine speed is in the optimal range.

16. In a tachometer display for displaying the speed of an engine that is powering a vehicle, an improvement comprising indicia associated with the tachometer display that identifies a current engine speed relative to an optimal range of engine speed, wherein the optimal range defines upper and lower limits of engine speed in which the fuel efficiency of the engine is maximized.

17. The improvement as recited in claim 16, wherein the tachometer display is in a first color when the current engine speed is in the optimal range and in a color other than the first color when the engine speed not in the optimal range.

18. The improvement as recited in claim 16, wherein auditory feedback is provided when the current engine speed is not in the optimal range.

19. The improvement as recited in claim 16, wherein haptic feedback is provided when the current engine speed is not in the optimal range.

20. The improvement as recited in claim 16, wherein the indicia is a bar graph with scale indicators that identifies an upper and lower RPM of the optimal range.
